(19) United States
(12) Patent Application Publication
(10) Pub. No.: US 2013/0206702 A1
(43) Pub. Date: Aug. 15, 2013

(54) FLUID TAILINGS FLOCCULATION AND DEWATERING USING CHEMICALLY-INDUCED MICRO-AGGLOMERATES

(71) Applicants: Christopher Lin, Calgary (CA); Payman Esmaeili, Calgary (CA); Ronald D. Myers, Calgary (CA)

(72) Inventors: Christopher Lin, Calgary (CA); Payman Esmaeili, Calgary (CA); Ronald D. Myers, Calgary (CA)

(21) Appl. No.: 13/753,125

(22) Filed: Jan. 29, 2013

(30) Foreign Application Priority Data
Feb. 15, 2012 (CA) 2767510

(51) Int. Cl. C02F 1/52

(52) U.S. Cl. CPC C02F 1/5236; Y10S 977/773; Y10S 977/902; B82Y 99/00
USPC 210/728; 210/723; 977/773; 977/902

(57) ABSTRACT

A process for tailings flocculation and dewatering is disclosed. In particular, disclosed is a method for generating chemically-induced micro-agglomerates (CIMA) of fine particles in a fluid tailings stream and using the micro-agglomerates to enhance tailings flocculation and dewatering.

### CROSS-REFERENCE TO RELATED APPLICATIONS

This application claims the priority benefit of Canadian Patent Application 2,767,510 filed Feb. 15, 2012 entitled FLUID TAILINGS FLOCCULATION AND DEWATERING USING CHEMICALLY-INDUCED MICRO-AGGLOMERATES, the entirety of which is incorporated by reference herein.

### FIELD

The present disclosure relates generally to the field of processing of mined oil sands. More particularly, the present disclosure relates to the treatment of tailings from an oil sands bitumen extraction process that generates tailings comprising fine particles such as clays.

### BACKGROUND

Fluid tailings streams are typically by-products of mining operations that are composed of water and solid particles. In order to recover the water and consolidate the solids, solid/liquid separation techniques must be applied. In oil sands processing, there are different fluid tailings streams with different compositions. For example, a typical fresh tailings stream comprises water, sand, silt, clay and residual bitumen. However, if the tailings stream is derived from a froth treatment process, it will also comprise residual solvents and other hydrocarbonaceous materials (e.g. asphaltenes).

Oil sands tailings typically comprise a substantial amount of fine particles (defined as solids that are less than 44 microns) and clays. The bitumen extraction process utilizes hot water and chemical additives such as sodium hydroxide or sodium citrate to remove the bitumen from the solid particles. The side effect of these chemical additives is that they change the inherent water chemistry and thus the solids in the aqueous phase acquire a negative charge. Due to strong electrostatic repulsion, the fine particles form a stabilized suspension that does not settle by gravity, even after a considerable amount of time. In fact, if the suspension is left alone for 3-5 years, a gel-like layer known as mature fine tailings (MFT) will be formed and this type of tailings is very difficult to consolidate even with current technologies.

In oil sands tailings treatment, various types of polyacrylamides (PAM) have been tested for the flocculation of tailings solids. While polyacrylamides are generally useful for fast consolidation of tailings solids, they are not selective towards fine particles and clays. As a result, the water recovered from a PAM consolidation process is rarely good enough for recycling because of high fines content in the water. Therefore, this water needs to be placed in a tailings pond where the fine particles eventually turn into MFT. Additionally, tailings treated with PAM are shear sensitive so transportation of thickened tailings to a dedicated disposal area (DDA) and general materials handling can become a challenge.

US Patent Application Publication US 2010-0187181 (Sortwell) describes the use of zeolite to assist in the dispersion of components in aqueous mineral slurries to release and separate individual components of the slurry. Upon dispersion, Sortwell describes a process to consolidate residual mineral solids using multivalent cations and polyacrylamide (PAM).

US Patent Application Publication US 2010-0126910 (Moffett et al.) describes the treatment of a tailings steam by contacting it with a polysilicate microgel, a polyacrylamide, a multivalent metal compound and/or a low molecular weight cationic organic polymer.

The synthesis of polysilicate microgel was described in a series of patents, including for example, U.S. Pat. No. 4,927,498 (Rushmere), U.S. Pat. No. 4,954,220 (Rushmere), U.S. Pat. No. 6,060,523 (Moffett et al.) and U.S. Pat. No. 6,274,112 (Moffett et al.).

Canadian Patent No. 2 515 581 and US Patent Application Publication US 2006-0207946 (Scammell et al.) describe a process in which material comprising an aqueous liquid with dispersed particulate solids is transferred as a fluid to a deposition area, then allowed to stand and rigidify, in which rigidification is improved with an effective rigidifying amount of aqueous solution of a water-soluble polymer.

### SUMMARY

It is an object of the present disclosure to obviate or mitigate at least one disadvantage of previous systems or methods.

The present disclosure provides a process in which chemically-induced micro-agglomerates (CIMA) of fine particles are formed in the fluid tailings stream. Micro-agglomerates are predominately much less than 1 mm in diameter, with the majority between 2 and 100 microns, and they principally comprise fine particles of the oil sands. The chemically-induced micro-agglomerates, when combined with a typical PAM, can enhance tailings flocculation and dewatering. In addition, the chemically-induced micro-agglomerates enhance dewatering, flocculation, and lead to an increase in the strength of the tailings deposit. Simply put, the tailings deposit following the CIMA process generally has a greater strength than PAM treated tailings. The disclosed process allows water recycling (for example to an extraction process) to be an option and may reduce the size of the tailings pond significantly by increasing the dewatering of the tailings.

In one aspect, the present disclosure provides a method for treating a tailings stream from an oil sands bitumen extraction process, the tailings stream comprising fine particles and clays, the method including conditioning the tailings stream with an aluminate to produce a conditioned tailings stream, and treating the conditioned tailings stream with a silicate to produce a treated tailings stream comprising chemically-induced micro-agglomerates (CIMA) and water.

In an embodiment disclosed, the silicate is a polysilicate. In an embodiment, the polysilicate is selected from the group consisting of sodium silicate, potassium silicate, and mixtures thereof.

In an embodiment disclosed, the silicate comprises a colloidal silica. In an embodiment, the colloidal silica is selected from the group consisting of cationic silica, anionic silica, modified colloidal silica, ammonium silica, low sodium silicate, and mixtures thereof. In an embodiment disclosed, the colloidal silica is 7 to 50 nm, with a surface area between 60 and 400 m²/g SiO₂. In an embodiment, the colloidal silica is selected from the group consisting of 7 nm with a surface area between 320 and 400 m²/g SiO₂, 12 nm with a surface area of between 198 and 258 m²/g SiO₂, 22 nm with a surface area between 110 and 150 m²/g SiO₂, 50 nm with a surface area between 60 and 90 m²/g SiO₂, and combinations thereof.

In an embodiment disclosed, the aluminate comprising sodium aluminate. In an embodiment, the aluminate is selected from the group consisting of potassium aluminate, aluminum sulfate, aluminum oxide, aluminum chloride, polyaluminum chloride, polyaluminum sulfate, and mixtures thereof.

In an embodiment disclosed, the method includes mixing the treated tailings stream. In an embodiment, the mixing is provided by transporting the treated tailings stream through a pipeline.

In an embodiment disclosed, the method includes adding an organic agglomerating polymer after the formation of the CIMA to produce a flocculated tailings stream.

In an embodiment disclosed, the agglomerating polymer includes a flocculating polymer. In an embodiment disclosed, the flocculating polymer comprises a polyacrylamide (PAM). In an embodiment disclosed, the organic agglomerating polymer is selected from the group consisting of: a cationic, anionic, nonionic or amphoteric polyacrylamide, a copolymer of acrylamide and diallyl dimethyl ammonium chloride, a copolymer of acrylamide and diallylaminoalkyl (meth)acrylates, a copolymer of acrylamide and dialkyldiaminoalkyl (meth)acrylamide, and mixtures thereof.

In an embodiment disclosed, the method includes discharging the flocculated tailings stream to a dedicated disposal area (DDA). In an embodiment disclosed, water is collected from the DDA for recycling.

In an embodiment disclosed, the aluminate includes an aluminate complex.

In an embodiment disclosed, the tailings stream is alkaline.

In an embodiment disclosed, the tailings stream includes coarse sand tailings or fine tailings or a combination of coarse sand tailings and fine tailings.

In an embodiment disclosed, the aluminate includes sodium aluminate and the silicate includes colloidal silica.

In an embodiment disclosed, the tailings stream comprises flotation or middling tailings. In an embodiment disclosed, the tailings stream is treated with 10 to 2000 ppmw SA, 10-2000 ppmw CS, and 50-1000 ppmw PAM. In an embodiment disclosed, the tailings stream is treated with 200-1000 ppmw SA, 20-100 ppmw CS, and 100-1000 ppmw PAM. In an embodiment disclosed, the tailings stream is treated at a temperature in a range of 10° C. to 40° C.

In an embodiment disclosed, the tailings stream comprises froth treatment tailings. In an embodiment disclosed, the tailings stream is treated with 10-1000 ppmw SA, 10-1000 ppmw CS, and 25-500 ppmw PAM. In an embodiment disclosed, the tailings stream is treated with 10 ppmw SA, 10 ppmw CS, and 50-100 ppmw PAM. In an embodiment disclosed, the tailings stream is treated at a temperature in a range of 60° C. to 95° C.

In an embodiment disclosed, the tailings stream comprises MFT. In an embodiment disclosed, the tailings stream is treated with 10-4000 ppmw SA, 10-4000 ppmw CS, and 100-2000 ppmw PAM. In an embodiment disclosed, the tailings stream is treated with 1000-2000 ppmw SA, 100-2000 ppmw CS, and 500-2000 ppmw PAM. In an embodiment disclosed, the tailings stream is treated at a temperature in a range of 5° C. to 30° C. In an embodiment disclosed, the range is 5° C. to 20° C. In an embodiment disclosed, the method includes diluting the MFT with water prior to treating the tailings stream.

In an embodiment disclosed, the tailings stream comprises Thickened Tailings (TT). In an embodiment disclosed, the tailings stream is treated with 10-2000 ppmw SA, 10-2000 ppmw CS, and 50-1000 ppmw PAM. In an embodiment disclosed, the tailings stream is treated with 200-1000 ppmw SA, 20-100 ppmw CS, and 100-1000 ppmw PAM. In an embodiment disclosed, the tailings stream is treated at a temperature in a range of 10° C. to 40° C.

In an embodiment disclosed, the tailings stream comprises PSV or Coarse Tailings. In an embodiment disclosed, the tailings stream is treated with 10-1000 ppmw SA, 10-1000 ppmw CS, and 10-500 ppmw PAM. In an embodiment disclosed, the tailings stream is treated with 10 ppmw SA, 10 ppmw CS, and 10-200 ppmw PAM. In an embodiment disclosed, the tailings stream is treated at a temperature in a range of 20° C. to 40° C.

In an embodiment disclosed, the method includes increasing the alkalinity of the tailings stream prior to conditioning the tailings stream.

In an embodiment disclosed, the method includes conditioning or treating or both conditioning and treating the tailings stream with a tailings treating technology. In an embodiment disclosed, the tailings treating technology is selected from the group of thickening, centrifugation, and in-line flocculation. In an embodiment disclosed, the method includes following the tailings treating technology with thin or thick lift drying.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 is a simplified flow diagram illustrating an overview of a method of forming chemically-induced micro-agglomerates (CIMA) according to one disclosed embodiment; and

FIG. 2 is a simplified flow diagram illustrating an overview of in-line flocculation of flotation tailings using the disclosed chemically-induced micro-agglomerates (CIMA) process according to one disclosed embodiment.

### DETAILED DESCRIPTION

Generally, the present disclosure provides a method and system for treating oil sands extraction tailings using chemically-induced micro-agglomerates.

In the disclosed method, chemically-induced micro-agglomerates (CIMA) of fine particles are produced in a fluid tailings stream and are utilized to enhance overall tailings flocculation and dewatering. The chemically-induced micro-agglomerates are formed by an in situ chemical reaction that binds the fine particles together (including clays). The CIMA process enhances the quality of the discharged water and creates chemically-bonded microstructures of fine particles that are stronger and more shear resistant than traditional flocs formed by physical consolidation.

The process of generating chemically-induced micro-agglomerates of fine tailings involves forming a chemical bond between the fine particles and clays.

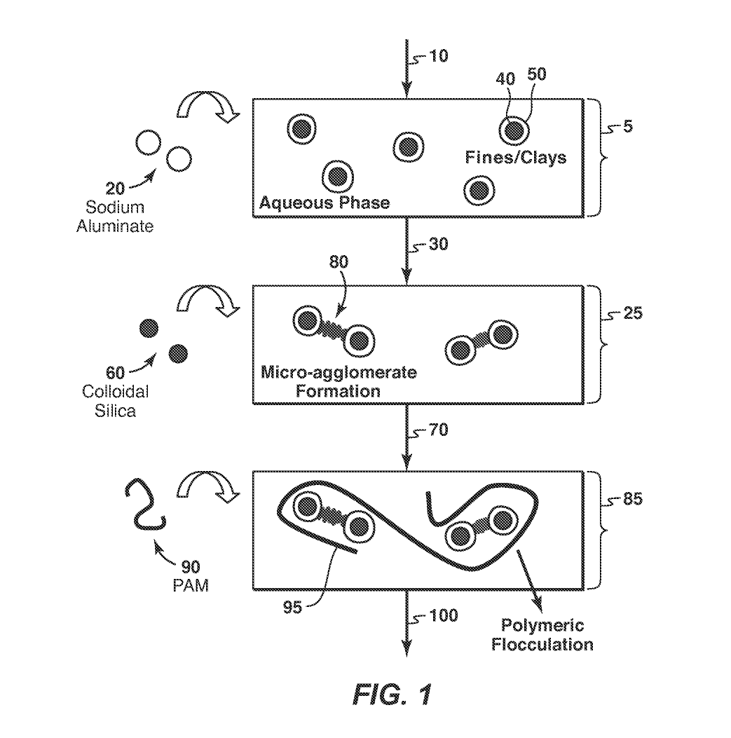

Referring to FIG. 1, in a conditioning stage 5, a tailings stream 10 from an oil sands bitumen extraction process is conditioned with an aluminate, such as sodium aluminate 20 (or similar aluminum species, including but not limited to, potassium aluminate, aluminum sulfate, aluminum oxide, aluminum chloride, polyaluminum chloride, or polyaluminum sulfate) to produce a conditioned tailings stream 30. In alkaline environments (e.g. oil sands tailings), fine particles and clays 40 carry a negative charge characterized by a negative zeta potential. Aluminate complexes can neutralize the negative charge and form a layer of coating 50 around the fine particles and clays 40. When this occurs, natural coagulation begins due to van der Waals interactions.

After the conditioning stage 5, the conditioned tailings stream 30 is treated, in a treating stage 25, with a silica, such as commercial colloidal silica 60 to produce treated tailings 70. In the treating stage 25, a series of polycondensation reactions begin to occur as soluble silica reacts instantaneously or quickly with aluminate complexes to form a stable, chemical bond. The net effect of this in situ bonding is the rearrangement of the fine particles and clays 40 into a “chemically-induced micro-agglomerate” (CIMA) 80.

After the formation of the CIMA 80, a flocculent, such as a polyacrylamide (PAM) 90 may be added to the treated tailings 70, in a flocculating stage 85, to increase the settling rate and allow dense, “macro-agglomerates” 95 of particles to form through polymeric flocculation to produce a flocculated tailings stream 100.

In an embodiment disclosed, the aluminate (for example sodium aluminate) may be added before, or concurrently with the silicate (for example colloidal silica). In an embodiment disclosed, the silicate (for example colloidal silica) may be added before, or concurrently with the aluminate (for example sodium aluminate).

In an embodiment disclosed, the flocculent may be any suitable organic agglomerating polymer, including but not limited to, any cationic, anionic, nonionic or amphoteric polyacrylamides, a copolymer of acrylamide and diallyl dimethyl ammonium chloride, a copolymer of acrylamide and diallylaminoalkyl (meth)acrylates, and a copolymer of acrylamide and dialkyldiaminoalkyl (meth)acrylamide.

As used herein, the flocculated “macro-agglomerates” are generally greater than 500 microns, up to millimeters in size. These “macro-agglomerates” comprise both the fine particles (less than 44 microns) and sand grains of the oil sands. The addition of the PAM 90 increases the overall dewatering rate due to enhanced settling rate.

The method described herein provided enhanced quality of water discharged from the flocculated tailings stream 100 and the chemically-bonded microstructures of fine particles are stronger and more shear resistant than flocs formed by a typical polyacrylamide (PAM) without conditioning and treating to form the CIMA 80.

The method described herein for tailings flocculation and dewatering may be utilized in relation to various tailings treating technologies including thickening, centrifugation, and in-line flocculation followed by thin or thick lift drying. Due to the robustness of the method described herein, the method may be applied to various oil sands tailings streams including flotation/middling tailings, froth treatment tailings (including paraffinic froth treatment (PFT) or naphthenic froth treatment (NFT)), mature fine tailings (MFT), primary separation vessel (PSV)/coarse tailings, and thickened tailings (TT).

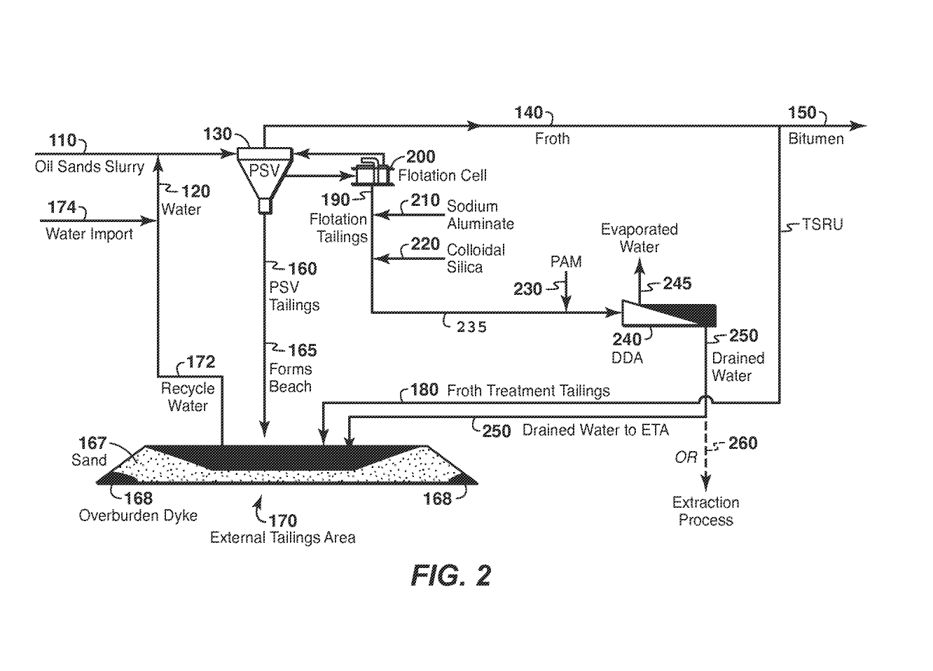

In-line flocculation of flotation tailings using the method described herein is illustrated in FIG. 2, in context with a known process for extracting bitumen from oil sands.

Referring to FIG. 2, an oil sands slurry 110, with water 120 is conveyed to a Primary Separation Vessel (PSV) 130 where through known processes froth 140 carries bitumen 150 for recovery. PSV tailings 160, which are relatively coarse sand tailings, are collected in an external tailings area 170, tending to form what is referred to as a beach 165 comprising sand 167. An overburden dyke 168 holds the sand 167 in place. Recycle water 172 may be recovered from the ETA 170 and be recycled as a source of water 120. Import water 174 may also provide a source of water 120.

Froth treatment tailings 180 from a Tailings Solvent Recovery Unit (TSRU) are also collected in the external tailings area 170. Flotation tailings 190 from flotation cell 200 are treated using the method disclosed herein.

Sodium aluminate 210, colloidal silica 220 and polyacrylamide (PAM) 230 are added in sequence, for example by pumping, injection, or otherwise, into a pipeline 235 extending between the flotation cell 200 and a dedicated disposal area (DDA) 240 where the flocculated tailings are discharged. In an embodiment disclosed, between 100 ppmw and 1000 ppmw of sodium aluminate, which represents 100 and 1000 g/T of dry tailings, colloidal silica of between 10 and 1000 ppmw with respect to dry tails, and PAM of between 50 and 500 ppmw with respect to dry tails are added.

The sodium aluminate (SA), colloidal silica (CS) and PAM may be added as aqueous solutions. In an embodiment disclosed, the concentration of SA and CS is generally about 1 wt %. This means 1 g of SA solid or CS liquid in 99 g of distilled water. The mixture is well mixed and added to the tailings. PAM generally comes as solids and is mixed with water. In an embodiment disclosed, PAM solution having a concentration of between about 0.1 wt % and about 0.5 wt % solution may be used.

In embodiments disclosed, flotation and middling tailings, froth treatment tailings, mature fine tailings, thickened tailings, PSV/coarse tailings, or combinations thereof, may be treated according to the following formulations, which are examples only.

### Flotation and Middling Tailings

In an embodiment disclosed, flotation/middling tailings may be treated according to the recipe: 10 to 2000 ppmw SA; 10-2000 ppmw CS; and 50-1000 ppmw PAM. In an embodiment disclosed, flotation/middling tailings may be treated according to the recipe: 200-1000 ppmw SA; 20-100 ppmw CS; and 100-1000 ppmw PAM.

In an embodiment disclosed, flotation/middling tailings may be treated at a temperature between about 10° C. and about 40° C.

### Froth Treatment Tailings (PFT and NFT)

In an embodiment disclosed, froth treatment tailings may be treated according to the recipe: 10-1000 ppmw SA; 10-1000 ppmw CS; and 25-500 ppmw PAM. In an embodiment disclosed, froth treatment tailings may be treated according to the recipe: 10 ppmw SA; 10 ppmw CS; and 50-100 ppmw PAM.

In an embodiment disclosed, froth treatment tailings may be treated at a temperature between about 60° C. and about 95° C.

### Mature Fine Tailings (MFT)

In an embodiment disclosed, MFT may be treated according to the recipe: 10-4000 ppmw SA; 10-4000 ppmw CS; and 100-2000 ppmw PAM. In an embodiment disclosed, MFT may be treated according to the recipe: 1000-2000 ppmw SA; 100-2000 ppmw CS; and 500-2000 ppmw PAM.

In an embodiment disclosed, MFT may be treated at a temperature between about 5° C. and about 30° C. In an embodiment disclosed, the temperature may be between about 5° C. and about 20° C. In an embodiment disclosed, water may be used to dilute the MFT prior to treatment.

### Thickened Tailings (TT)

In an embodiment disclosed, thickened tailings (TT) may be treated according to the recipe: 10-2000 ppmw SA; 10-2000 ppmw CS; and 50-1000 ppmw PAM. In an embodiment disclosed, thickened tailings (TT) may be treated according to the recipe: 200-1000 ppmw SA; 20-100 ppmw CS; and 100-1000 ppmw PAM.

In an embodiment disclosed, thickened tailings may be treated at a temperature between about 10° C. and about 40° C.

### PSV/Coarse Tailings

In an embodiment disclosed, PSV/Coarse Tailings may be treated according to the recipe: 10-1000 ppmw SA; 10-1000 ppmw CS; and 10-500 ppmw PAM. In an embodiment disclosed, PSV/course tailings may be treated according to the recipe: 10 ppmw SA; 10 ppmw CS; and 10-200 ppmw PAM.

In an embodiment disclosed, PSV/Coarse tailings may be treated at a temperature between about 20° C. and about 40° C.

The high shear within the pipeline 235 provides the mixing needed for agglomerate formation. A portion of water from the DDA 240 may evaporate as evaporated water 245. Drained Water 250 may be drained or otherwise captured from the DDA 240 and may be used for an extraction process 260 or other re-use or heat recovery or a combination thereof, or sent to the ETA 170 for storage.

While the method described herein has been described in detail with respect to flotation tailings 190, it may similarly also be applied to PSV tailings 160 or froth treatment tailings 180, or other oil sands tailings, or combinations thereof.

Utilizing the method described herein, in-line flocculation directly treats fresh tailings and can reduce or potentially eliminate the formation of MFT.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A method for treating a tailings stream from an oil sands bitumen extraction process, the tailings stream comprising fine particles and clays, the method comprising:
conditioning the tailings stream with an aluminate to produce a conditioned tailings stream; and
treating the conditioned tailings stream with a silicate to produce a treated tailings stream comprising chemically-induced micro-agglomerates (CIMA) and water.

2. The method of claim 1, wherein the silicate is a polysilicate.

3. The method of claim 2, the polysilicate selected from the group consisting of sodium silicate, potassium silicate, and mixtures thereof.

4. The method of claim 1, wherein the silicate comprises a colloidal silica.

5. The method of claim 4, the colloidal silica selected from the group consisting of cationic silica, anionic silica, modified colloidal silica, ammonium silica, low sodium silicate, and mixtures thereof.

6. The method of claim 4, the colloidal silica selected from the group consisting of 7 nm with a surface area between 320 and 400 m²/g SiO₂, 12 nm with a surface area of between 198 and 258 m²/g SiO₂, 22 nm with a surface area between 110 and 150 m²/g SiO₂, 50 nm with a surface area between 60 and 90 m²/g SiO₂, and combinations thereof.

7. The method of claim 1, the aluminate comprising sodium aluminate.

8. The method of claim 1, the aluminate selected from the group consisting of potassium aluminate, aluminum sulfate, aluminum oxide, aluminum chloride, polyaluminum chloride, polyaluminum sulfate, and mixtures thereof.

9. The method of claim 1, further comprising adding an organic agglomerating polymer after the formation of the CIMA to produce a flocculated tailings stream.

10. The method of claim 9, the agglomerating polymer comprising a flocculating polymer.

11. The method of claim 10, wherein the flocculating polymer comprises a polyacrylamide (PAM).

12. The method of claim 9, wherein the organic agglomerating polymer is selected from the group consisting of: a cationic, anionic, nonionic or amphoteric polyacrylamide, a copolymer of acrylamide and diallyl dimethyl ammonium chloride, a copolymer of acrylamide and diallylaminoalkyl (meth)acrylates, a copolymer of acrylamide and dialkyldiaminoalkyl (meth)acrylamide, and mixtures thereof.

13. The method of claim 11, wherein the aluminate comprises sodium aluminate and the silicate comprises colloidal silica.

14. The method of claim 13, wherein the tailings stream comprises flotation or middling tailings.

15. The method of claim 14, wherein the tailings stream is treated with 10 to 2000 ppmw SA, 10-2000 ppmw CS, and 50-1000 ppmw PAM.

16. The method of claim 13, wherein the tailings stream comprises froth treatment tailings.

17. The method of claim 16, wherein the tailings stream is treated with 10-1000 ppmw SA, 10-1000 ppmw CS, and 25-500 ppmw PAM.

18. The method of claim 13, wherein the tailings stream comprises MFT.

19. The method of claim 18, wherein the tailings stream is treated with 10-4000 ppmw SA, 10-4000 ppmw CS, and 100-2000 ppmw PAM.

20. The method of claim 13, wherein the tailings stream comprises Thickened Tailings (TT).

21. The method of claim 20, wherein the tailings stream is treated with 10-2000 ppmw SA, 10-2000 ppmw CS, and 50-1000 ppmw PAM.

22. The method of claim 13, wherein the tailings stream comprises PSV or Coarse Tailings.

23. The method of claim 22, wherein the tailings stream is treated with 10-1000 ppmw SA, 10-1000 ppmw CS, and 10-500 ppmw PAM.
